(19) United States
(12) Patent Application Publication
(10) Pub. No.: US 2024/0367413 A1
(43) Pub. Date: Nov. 7, 2024

(54) REINFORCED CROSS-LAMINATED TIMBER PANEL

(71) Applicant: Sterling Site Access Solutions, LLC, Phoenix, IL (US)

(72) Inventors: Jeffery T. Faye, Chicago, IL (US); Carter Sterling, Palos Park, IL (US); Kevin Hsu, Lemont, IL (US)

(21) Appl. No.: 18/242,776

(22) Filed: Sep. 6, 2023

Related U.S. Application Data
(60) Provisional application No. 63/464,294, filed on May 5, 2023.

(51) Int. Cl. B32B 7/08; B32B 21/13; B32B 38/00

(52) U.S. Cl. CPC B32B 7/08; B32B 21/13; B32B 38/0004; B32B 2305/34; B32B 2317/16; B32B 2607/00

(57) ABSTRACT

A cross-laminated panel or mat can be comprised of a plurality of lumber/wood boards positioned and arranged in layers that alternate in transverse directions with respect to one another (hereinafter defined as a “cross-laminated panel” or a “panel”). The reinforced panel comprises a plurality of dowels specifically machined and sized wherein the plurality of dowels are dipped into and coated with adhesive. The plurality of dowels are further configured to be drilled and inserted into an existing bond line in order to enhance the service life and prevent edge delamination. In addition, a method of reinforcing the structural strength of a mat/panel is provided. The invention disclosed herein further comprises a method of reinforcing the structural strength of a cross-laminated timber mat/panel by infusing and dipping the cross-laminated mat/panel with a preservative or biofriendly pesticide to enhance the service life and prevent rotting and decaying.

### CROSS-REFERENCE TO RELATED APPLICATION

This application claims the benefit of and priority to U.S. Provisional Application No. 63/464,294 filed May 18, 2023, the contents of which are incorporated by reference.

### FIELD OF THE DISCLOSURE

The present disclosure generally relates to a reinforced cross-laminated timber panel or mat and method of using the same. More specifically, the present disclosure is directed to a cross-laminated timber panel (or mat) modified with dowels to withstand the stresses generated due to applied load as well as cyclic hygroscopic expansion and contraction throughout the service life of the cross-laminated timber panel (or mat). In addition, the present disclosure also relates to a dowel-reinforced cross-laminated timber panel (or mat) which can be dipped in or sprayed with a preservative or biofriendly pesticide to prolong its service life through the prevention of biological decay.

### BACKGROUND

A cross-laminated timber panel (or mat) is a multi-layer solid wood panel (or mat), generally comprised of solid wood boards with unique and often superior aesthetic, environmental, and cost attributes and can be used in various fields of use such as temporary roadway construction and/or ground protection. A cross-laminated panel or mat can be comprised of a plurality of lumber/wood boards positioned and arranged in layers (also referred as board layers) that alternate in transverse directions with respect to one another (hereinafter defined as a “cross-laminated panel” or a “panel”).

In various embodiments, such cross-laminated panels (primarily made of timber) may be manufactured using either softwood, hardwood, or any combination of softwood and hardwood. Cross-laminated panels—for example the Terralam products-provide various advantages such as (a) smooth and stable temporary roads and platforms; (b) freight savings up to 50% over hardwood bolted mats due to double the mats per truck; (c) sustainable product built with Southern Yellow Pine (SYP) or other soft wood species providing an avoidance of up to 50% of freight CO2 emissions; and (d) can be manufactured in a cost-effective manner with engineering specifications, production consistency, and consistent quality assurance.

One of the key disadvantages of such panels (or mats) is the service life of a cross-laminated panel, since such panels or mats are subjected to high pressures and stresses across both the wood that comprises the assembly and the adhesive that holds it together in an assembled formation of the panel or mat. Such stress can be generated through both loads as well as increased expansion of the material when in contact with additional moisture which is also known as cyclic hygroscopic expansion and contraction.

The load bearing stress along with the cyclic hygroscopic expansion and contraction can cause reduction in the overall strength of the adhesive bond lines which can eventually lead to the failure of the structure of the cross-laminated panel. For instance, in certain cross-laminated panels generated loads and cyclic hygroscopic expansion and contraction can potentially cause reduction in the overall strength of the adhesive bond lines that can eventually lead to the failure of the cross-laminated timber structure of the panel.

Many attempts have been made-conventional and other prior art apparatus and methods—to solve the foregoing problem of reduction in the service life of a cross-laminated panel due to high stresses and cyclic hygroscopic expansion and contraction. One such attempt has been to use certain dowels or bolts to provide lamination within the structure of the cross-laminated panel. However, such conventional and other prior art apparatus and methods solutions do not address the root cause of the issue causing the reduction of service life of a cross-laminated panel, as discussed below.

One conventional approach used to prolong the service life of a cross-laminated panel uses a plurality of standard dowels that are drilled and doweled perpendicular to the wood interfaces at each intersection of the lumber of the panel. In such dowel laminated timber for soft or hardwood structural panels—as they are generally known in the industry—the panels do not utilize adhesive or threaded dowels but rather use a smaller (e.g., 0.5″) diameter dowel to hold the wood structure together. At a minimum, these highly inefficient and cost-prohibitive dowel laminated timber or soft or hardwood structural panels do not provide the necessary structural strength needed to overcome the high stresses and cyclic hygroscopic expansion and contraction of the cross-laminated panel that are seen in service as access roads and ground protection.

One other disadvantage of such prior art and conventional apparatus and method is related to usage with the passage of time, since such dowel laminated timber has been known in the industry to lose its dimensional stability due to the issues related to aging of the fastener or dowel. Another conventional and/or prior art method used to prolong the service life of a cross-laminated panel is the standard cross-laminated bolted access mats. The bolted access mats are comprised of either hardwood or softwood and feature one or more bolts at each intersection. However, they do not utilize adhesive but instead utilize bolts to hold the lamination of mats. However, there are disadvantages to such mats, including, but not limited to, high cost to implement and the insertion of metal in the mat which can rust or decay, contaminating the environment, leading to end-of-service-life disposal issues and slow manufacture speed as compared to dowel reinforced mats disclosed herein. Further, even if some progress has arguably been made in dowel or bolt laminated panels as discussed above, there are additional disadvantages of such conventional approaches to enhance the service life of a mat. For example, many types of materials and wood do not provide the matched expansion and contraction characteristics of the various materials that can make such conventional dowel reinforced cross-laminated panels successful within the field or industry.

In sum, the currently available apparatus and method of improving the service life of a cross-laminated panel have various shortcomings and disadvantages as discussed above. Therefore, there is clearly a market need for improving the service life of a cross-laminated panel by overcoming the disadvantages and shortcomings of the prior art and conventional apparatus and method.

The present disclosure is directed to an apparatus and method comprising an improved reinforced cross-laminated panel to benefit customers using such panels throughout the service life of the panel. More particularly, the present disclosure is directed to a novel cross-laminated timber panel comprising a dowel reinforced boards arranged in layers in order to overcome stresses generated due to load and cyclic hygroscopic expansion and contraction. This panel may also include preservative or biofriendly pesticide dip or spray treatment to further prolong the service life of the cross-laminated timber panel by increasing the resistance of biological decay and rot.

### SUMMARY

Embodiments disclosed in the present disclosure provide an improved apparatus and method comprising a dowel-reinforced cross-laminated panel that may be dipped or sprayed with a certain type of treatment solution. In an aspect of the present disclosure, an apparatus and associated methods relating to a reinforced mat is provided. A reinforced mat can be comprised of a plurality of boards arranged in a plurality layers wherein each of the plurality of layers are laminated to an adjacent one of the layers. A plurality of dowels configured to be inserted to a bond line of each of the plurality of layers and at least one of the plurality of dowels is configured to be aligned to and inserted into the bond line of each of the plurality of layers in order to provide structural integrity and enhance the service life of the mat. As further disclosed herein, a plurality of dowels is configured to be inserted into of each of the plurality of layers wherein at least one dowel of the plurality of dowels is configured to be aligned to and inserted into a bond line of each of the plurality of layers to provide structural integrity and enhance the service life of each of the mat. As further described in the detailed disclosure below, a dowel reinforced cross-laminated panel is comprised of specifically machined and sized dowels that are dipped into and coated with adhesive and are then drilled and inserted perpendicular (either fully or partially) to the existing adhesive bond line. It is to be noted, by way of example and not of limitation, an aperture created for insertion of a dowel can be treated with a certain treatment solution or material and the dowel can be inserted after a certain pre-determined amount of time of such treatment prior to insertion (the soak-period). As further described below, each dowel can also be pre-soaked prior to insertion in a certain type of treatment solution or material.

In another aspect of the present disclosure, an apparatus and associated methods related to a dowel reinforced cross-laminated timber panel are provided. As disclosed herein, a dowel reinforced cross-laminated timber panel is comprised of specifically machined and sized dowels that are dipped into and coated with adhesive and are then drilled and inserted perpendicular to the existing adhesive bond line in order to prevent delamination of the cross-laminated panel and to help alleviate bondline stress caused by hygroscopic expansion and contraction.

In yet another aspect of the present disclosure, a method of reinforcing a plurality of layers of boards, the method comprising the steps of: (1) providing a plurality of dowels; (2) dipping each of the plurality of dowels into an adhesive; (3) laminating each of a plurality of layers of boards to an adjacent one of the layers of boards; (4) aligning each of the plurality of dowels along a bond line of each of the plurality of layers of boards; and (5) drilling and inserting each of the plurality of dowels into the bond line in order to provide structural integrity and enhance the service life of each of the plurality of layers of boards.

It is to be noted, as shown in the accompanying drawings and described in the detailed embodiment of the invention below, that various modifications of the dowel pattern can be utilized during the process of reinforcing the structural strength of a cross-laminated panel in order to achieve better modulation of chemical deposition during the production process related to one or more aspects of the present disclosure. For instance, one dowel pattern and configuration can be comprised of 60 dowels inserted at various locations along the bond line of each of the plurality of layers comprising the panel. Another modified dowel pattern and configuration can be comprised of more or less than 60 dowels inserted in a different configuration at the various locations along the bond line of each of the plurality of layers comprising the panel.

In still yet another aspect of the present disclosure, a method of reinforcing the structural strength of a cross-laminated timber panel comprises the step of infusing and dipping or spraying the cross-laminated mat with a preservative or biofriendly pesticide to enhance the service life and prevent rotting and decay of the cross-laminated timber panel.

This summary is provided to introduce a selection of concepts in a simplified form that are further described in the detailed description of the disclosure. This summary is not intended to identify key or essential inventive concepts of the claimed subject matter, nor is it intended for determining the scope of the claimed subject matter.

The references made in detail to the embodiments of the disclosure are provided by way of explanation of the disclosure, not in limitation of the disclosure. It will be apparent to those skilled in the art that various modifications and variations can be made in the present disclosure without departing from the scope or spirit of the disclosure.

Features illustrated or described as part of one embodiment can be used on another embodiment to yield a still further embodiment. Thus, it is intended that the present disclosure cover such modifications and variations as come within the scope of the appended claims and their equivalents. Other objects, features and aspects of the present disclosure are disclosed in the following detailed description.

It is to be understood by one of ordinary skill in the art that the present discussion is a description of exemplary embodiments only and is not intended as limiting the broader aspects of the present disclosure, which broader aspects are embodied in the exemplary constructions.

### BRIEF DESCRIPTION OF THE DRAWINGS

The disclosure will be more readily understood in view of the following description when accompanied by the below figures. The accompanying figures incorporated in and forming a part of the specification illustrate several aspects of the present invention and, together with the description, serve to explain the principles of the invention.

FIG. 1 illustrates an exemplary dowel machined and sized to certain specific dimensions to be drilled and inserted into the bond line of the plurality of layers comprising the panel according to one or more aspects of the present disclosure.

FIG. 2 illustrates a 3-ply dowel and a 5-ply dowel machined and sized to certain specific dimensions to be drilled and inserted into the bond line of the plurality of layers comprising the panel according to one or more aspects of the present disclosure.

FIGS. 3A-B illustrate exemplary novel dowelling pattern configurations to be inserted into the bond line of the plurality of layers comprising the panel having certain dimensions according to one or more aspects of the present disclosure.

FIGS. 4 and 5 illustrate an exemplary novel dowelling pattern configuration to be drilled and inserted into the bond line of the plurality of layers comprising the panel having certain specific dimensions according to one or more aspects of the present disclosure.

FIG. 6 illustrates a perspective view of an exemplary dowel reinforced cross-laminated timber panel according to one or more aspects of the present disclosure.

FIGS. 7A-B illustrate testing of the ¾″ wood dowels to secure the 3 ply layers together in an exemplary dowel reinforced cross-laminated timber panel according to one or more aspects of the present disclosure.

### DETAILED DESCRIPTION OF THE DISCLOSURE

For the purposes of promoting and understanding the principles disclosed herein, reference is now made to the preferred embodiments illustrated in the drawings, and specific language is used to describe the same. The disclosure below along with drawings is intended to be a description of various, illustrative embodiments of the disclosed subject matter.

Specific features and functionalities are described in connection with each illustrative embodiment; however, it will be apparent to those skilled in the art that the disclosed embodiments may be practiced without each of those specific features and functionalities. It is understood that no limitation of the scope of the disclosure is hereby intended. Such alterations and further modifications in the illustrated apparatus and such further applications of the principles disclosed and illustrated herein are contemplated as would normally occur to one of ordinary skill in the art to which this disclosure relates.

In an aspect of the present disclosure, in order to prolong the service life of a cross-laminated panel, a plurality of dowels are specially designed, machined and sized to certain dimensions and are dipped and coated with a certain adhesive. The adhesive coated dowels are then drilled and inserted perpendicular to the existing adhesive bond line of each of the plurality of layers comprising the panel. The dowels once inserted can provide the necessary structural reinforcement and integrity in order to prolong the service life of the cross-laminated panel by mitigating stresses created by bending and shear as well as cyclic hygroscopic expansion and contraction. Various kinds of dowel materials can be used. By way of example and not of limitation, a dowel disclosed herein can be manufactured, machined and sized from a certain red oak species having a board sawn orientation, as further illustrated below. It is to be noted that the plurality of boards arranged as a layer and comprising the panel can have various thicknesses and/or other dimensions as disclosed and used herein, including each board having a certain pre-determined thickness wherein the plurality of boards are cross-layered and glued.

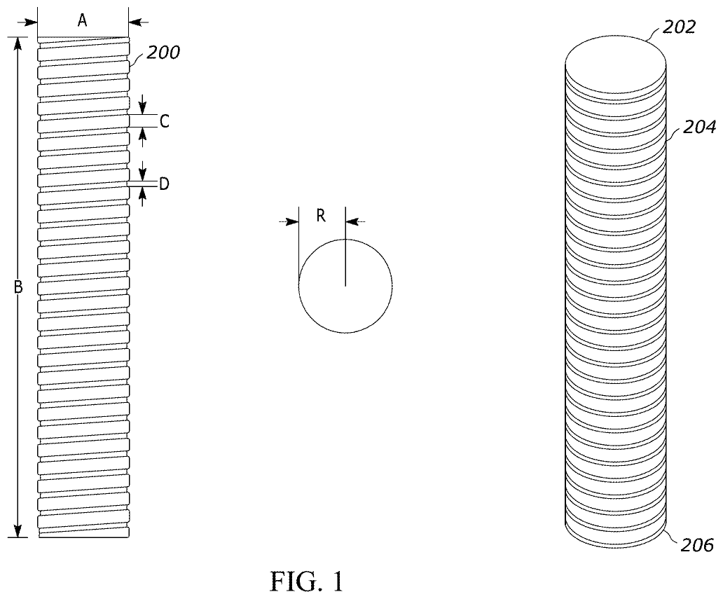

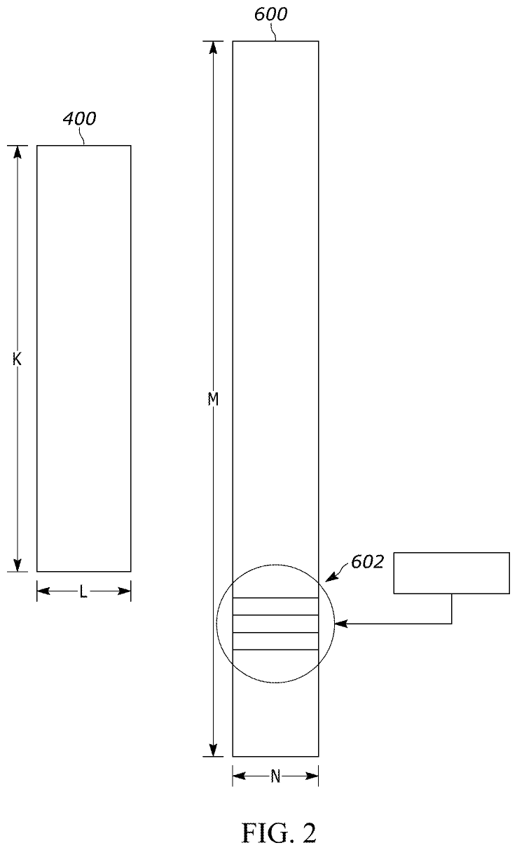

FIG. 1 illustrates an exemplary dowel machined and sized to certain specific dimensions to be drilled and inserted into the bond line of each of the plurality of layers comprising the panel according to one or more aspects of the present disclosure. FIG. 2 illustrates a 3-ply dowel and a 5-ply dowel machined and sized to certain specific dimensions to be drilled and inserted into the bond line of each of the plurality of layers comprising the panel according to one or more aspects of the present disclosure.

As illustrated in FIGS. 1 and 2, the dowel 200 is specially machined and sized with a certain diameter (A) and height (B) along with the scored thread pattern (204) that can be drilled and inserted into (perpendicular to or at a slight angle to) the existing adhesive bond line of each of the plurality of layers comprising the panel. It is to be noted that by way of example and not of limitation, in one of the many embodiments, the dowel (200) can have a height of 4.14 (B) inches with a diameter of 0.75 (A) inches and with thread-pattern dimensions of 0.1 inches (C) and 0.04 inches (D). FIG. 2 shows specially machined and sized dowels along with the scored thread pattern in a 3-ply dowel (400) and a 5-ply dowel (600) for a cross-laminated timber panel. As illustrated, the 3-ply dowel (400) and a 5-ply dowel (600) can be machined and sized to certain specific dimensions (noted in reference letters K, L, M and N respectively). By way of example and not of limitation, the 3-ply dowel (400) can have a length of 4.125 inches and a diameter of 0.75 inches. Similarly, by way of example and not of limitation, the 5-ply dowel (600) can have a length of 6.875 inches and a diameter of 0.75 inches. As further depicted in FIG. 2, the 5-ply dowel (600) includes a machined scored-thread pattern 602. It is to be noted that the specially machined and sized dowels (shown as 200, 400 and 600 in FIGS. 1 and 2) can be drilled and inserted perpendicular or at a certain modified angle to an existing adhesive bond line of each of the plurality of layers comprising the panel and having a certain height and width.

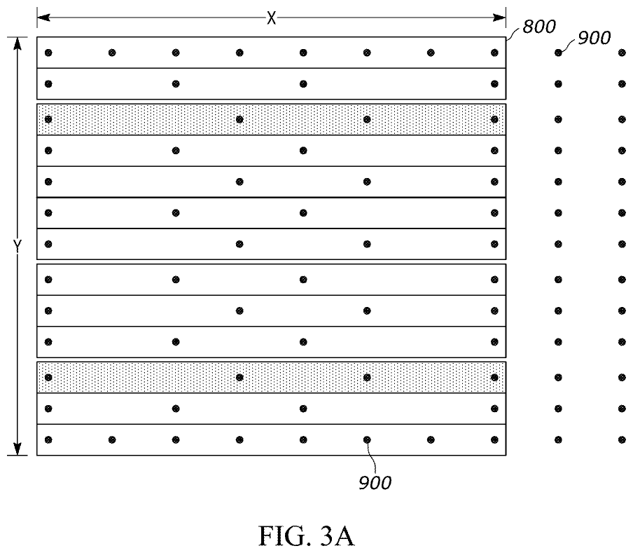

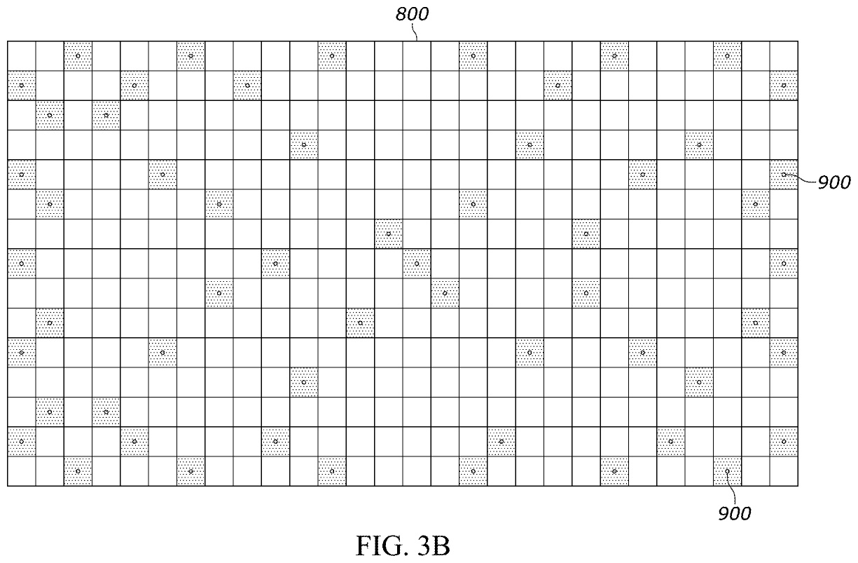

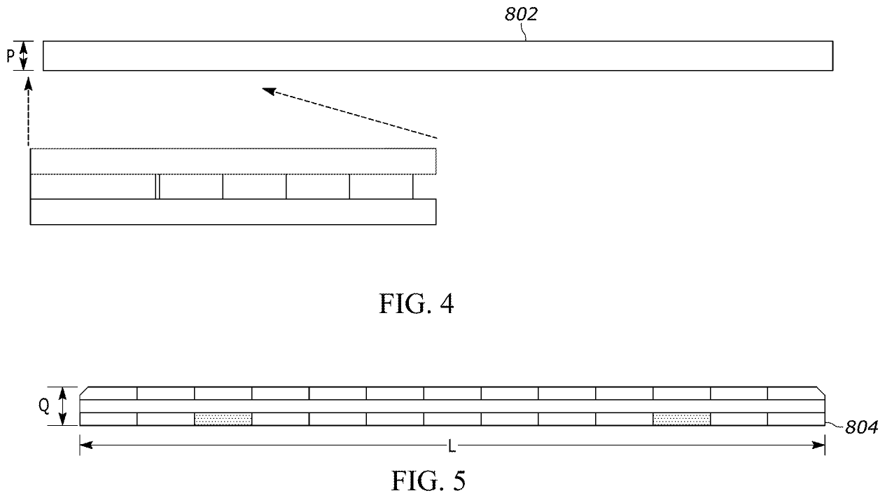

FIGS. 3A-B illustrate an exemplary novel dowelling pattern configuration having a plurality of dowels 900 inserted perpendicular to the existing adhesive bond line of each of the plurality of layers comprising the panel (800) and having a certain pre-determined length (X) and height (Y), according to one or more aspects of the present disclosure. It is to be noted that in various embodiments there are modifications of the dowel pattern 900 (as shown in an exemplary embodiment in FIG. 3B) to allow for better modulation of chemical deposition during the production process related to the one or more aspects of the present disclosure. FIGS. 4 and 5 illustrate an exemplary novel dowelling pattern configuration to be drilled and inserted into the existing adhesive bond line of each of the plurality of layers comprising the panels (802, 804)—the plurality of boards arranged and layered to a certain pre-determined height and configured according to one or more aspects of the present disclosure. The exemplary novel dowelling pattern 900 can be configured to be inserted perpendicular or at a slight angle to the existing adhesive bond line of each of the plurality of layers comprising the panel according to one or more aspects of the present disclosure and further illustrated in FIGS. 3A-B, 4 and 5.

In alternative embodiments, the various sizes and types of boards arranged in layers and comprising a panel can be used for the dowel 900 reinforcement. By way of example and not of limitation, in other embodiments a 3-, 5- (shown in FIG. 2) or 7-ply cross-laminated panel measuring approximately 8′×14′, 16′ or 18′ can be drilled and inserted with 0.75″ diameter red oak dowels. As disclosed herein, the layout and configuration of the dowel (200, 400, 600 and 900) inserted and placed within the bond line of each of the plurality of layers comprising the panel is further optimized to prevent delamination in areas of high damage during use of the cross-laminated panels.

The novel dowelling pattern configuration 900 (as shown in FIGS. 3A-B) to be drilled and inserted into the existing adhesive bond line of each of the plurality of layers comprising the panel provides panel reinforcement while reducing the overall utilization costs of adding the dowels (200, 900). As further disclosed herein, a dowel reinforced cross-laminated timber panel (800, 802, 804) can be utilized in the structural cross-laminated timber (CLT) market for providing improved structural panels in the ground retention market with some slight modifications to provide for the ground reinforcement.

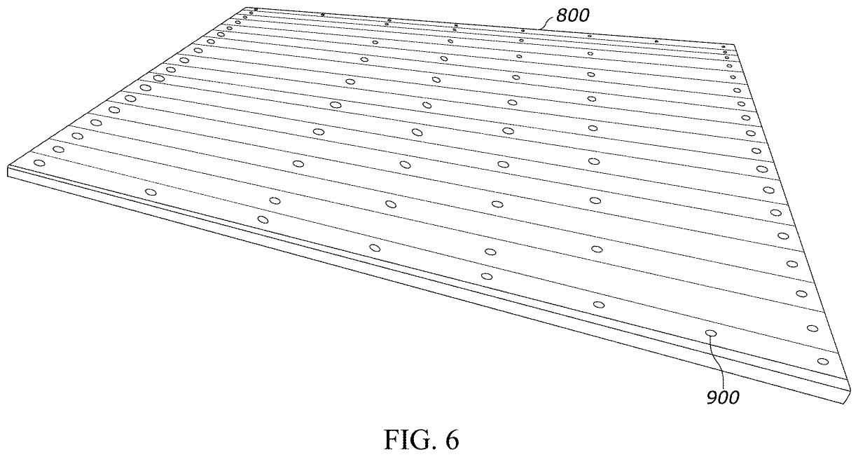

As further noted in the detailed description, each dowel 900 can be drilled either partially or throughout the entirety of the cross-laminated panel 800. It is to be noted that the dowels 900 can be inserted with water, adhesive or without either water or adhesive and can be manufactured from various types of wood species. In addition, the dowels 900 disclosed herein are not limited to any specific dimensions (e.g., a diameter, height, thread patterns, etc.) and can be machined and sized to different dimensions to drill and insert them perpendicular to the existing adhesive bond line of the cross-laminated timber panel 800. FIG. 6 illustrates a perspective view of an exemplary dowel 900 reinforced cross-laminated timber panel 800 according to one or more aspects of the present disclosure. It is to be noted that various advantages provided by the specially machined and sized dowels (200, 400, 600 and 900) drilled and inserted perpendicular to the existing adhesive bond line of each of the plurality of layers comprising the panel include (1) longer service life for industrial matting and structural applications and (2) reduced glue bond line stress during use of the panels (800, 802, 804).

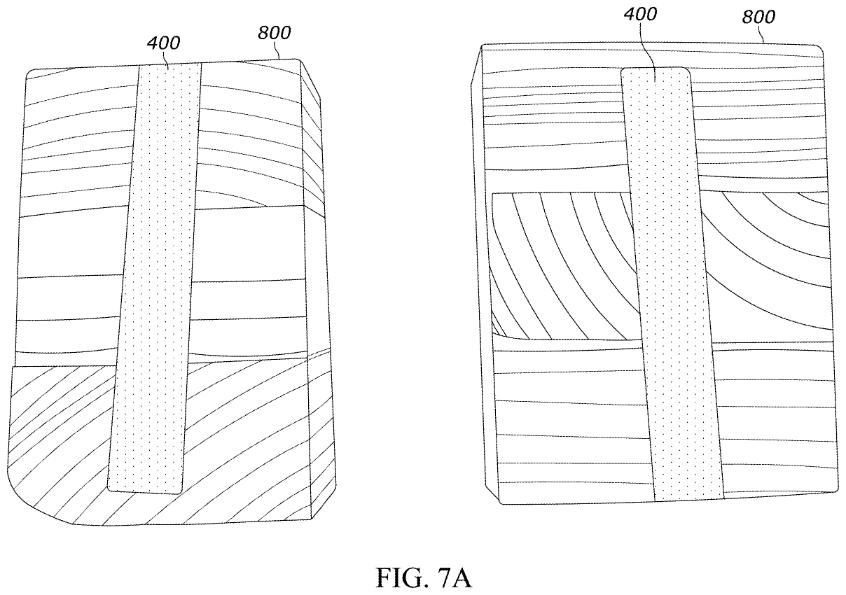

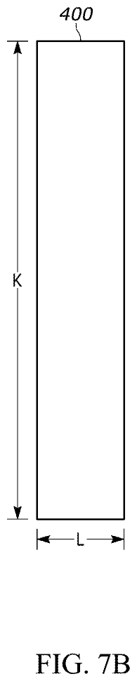

FIGS. 7A-B illustrate testing procedures for the ¾″ wood dowels 400 to secure the 3-ply layers together in an exemplary dowel reinforced cross-laminated timber panel (800, 802, 804) according to one or more aspects of the present disclosure. As illustrated in FIGS. 7A-B, testing of the ¾″ wood dowels 400 to secure 3-ply layers of a cross-laminated timber layer was conducted in order to test the feasibility by using two new boards which were glued together (using urethane-based PL2 and UR2 as well as a combination of both) and mounted around a fully saturated (via vacuum) used board to form the 3-ply layers cross-laminated timber panels.

In yet another aspect of the present disclosure, the dowel size is not limited to ¾″ and other sizes of dowels can be used for this testing. The result of the initial testing was promising wherein the initial hold of the ¾″ wood dowels was quite strong within the 3-ply layers cross-laminated timber panel. By way of example and not of limitation, the 3-ply layers were subjected to shear, delamination and creep (hydrate and dehydrate multiple times) tests. It is to be noted that various other alternative adhesives to urethane-based PL2 can be used such as Cyberbond (Cybercryl 800, 805), Atom Adhesives (Stalking Epoxy), Permabond (ET536-ET538) and other similar types of adhesives.

In another aspect of the present disclosure, specially machined and sized dowels (200, 400, 600 and 900) drilled and inserted perpendicular to the existing adhesive bond line of each of the plurality of layers comprising the panel (800) provide for better board retention with less delamination over time and usage of the cross-laminated timber panel. It is to be noted that such novel and unique dowel reinforcement provides-among other advantages-more cost-effective, efficient and faster ways to install dowels than bolts and other kinds of similar fasteners.

In yet another aspect of the present disclosure, specially machined and sized dowels (200, 400, 600 and 900) are drilled either partially or throughout the entirety of the plurality of layers comprising the panel and inserted perpendicular to the existing adhesive bond line of each of the plurality of layers comprising the panel 800. As noted above, such novel and unique dowel reinforcement provides-among other advantages-more cost-effective, efficient and faster ways to install dowels than bolts and other kind of similar fasteners. In alternative embodiments, as disclosed herein, dowels can be inserted perpendicular or at a slight angle to the adhesive bond line.

In other embodiments, within the scope of the disclosure herein, dowels can be inserted either with water, adhesive or even without either water or adhesive. Various alternative embodiments of the dowel (200, 400, 600 and 900) used for reinforcing the plurality of boards arranged in layers—the layers comprising the panel—can have modified insertion angles for the dowel, as well as a scoring plate that can be used to create a small amount of compression during insertion and the addition of high-tack glue to the patching process to provide a shock-proof temporary hold of the plurality of layers (wood layers) of the cross-laminated timber panel.

In yet another aspect of the present disclosure, to prolong the service life of cross-laminated panels (800, 802, 804), specially designed, machined and sized (to certain dimensions) dowels (200, 400, 600 and 900) are dipped and coated with a certain adhesive. The adhesive coated dowels (200, 400, 600 and 900) are then drilled and inserted perpendicular to the existing adhesive bond line of each of the plurality of layers comprising the boards (800, 802, 804) to eliminate edge delamination of the panels. As disclosed herein, by way of example and not of limitation, the dowels (200, 400, 600 and 900) used can be ¾″ red oak dowels which can eliminate potential for board separation in the cross-laminated timber panel.

In another aspect of the present disclosure, the dowels (200, 400, 600 and 900) are drilled and inserted to eliminate edge delamination while simultaneously reinforcing and improving the structural strength of the leading edges of the panels (800, 802, 804) to protect against leading edge damages during handling of the panels (800, 802, 804). It is to be noted, by way of example and not of limitation, the dowel reinforcement mechanism disclosed herein increases the board retention of the panel or mat leading to better on-the-job performance while eliminating any puncture and flat risks caused by screws and bolts. In addition, using such novel and unique methods removes any disposal restrictions during field use of the cross-laminated panels.

In another aspect of the present disclosure, in order to prolong the service life of cross-laminated timber panels (800, 802, 804) and reduce rot and decay of the panel, the plurality of boards arranged in a plurality of layers are infused with, sprayed or dipped into preservative or biofriendly pesticide. It is to be noted that such preservative or biofriendly pesticide (e.g., Cellu-Treat Wood Preservative) can be obtained over the counter and does not need to be specially manufactured. As disclosed herein, the dipped the layers can prevent and inhibit fungal and mold growth in the wood. Further, such environmentally friendly, non-restricted use of pesticide, which after treatment reverts to natural micronutrients, can promote tree growth and pest resistance and provide additional environmental advantages in the field of use. In various testing, levels of heavy metals and dioxins were lower than the applicable limits allowed for such metals and dioxins in the bio-infused cross-laminated timber panel.

In yet another aspect of the present disclosure, using such novel and unique methods removes any disposal restrictions during field use of the cross-laminated panels. In another aspect of the present disclosure, such anti-fungal treatments—for instance a dip borate treatment done during the doweling process (after drilling and prior to insertion)—would allow the deposition of an effective pesticide such as a borate that would increase the rot resistance of the cross-laminated panel.

It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

Various features of the example embodiments described herein may be implemented using hardware, software, or a combination thereof and may be implemented in one or more computer systems or other processing systems. However, the manipulations performed in these embodiments were often referred to in terms, such as determining, which are commonly associated with mental operations performed by a human operator. No such capability of a human operator is necessary in any of the operations described herein. Rather, the operations may be completely implemented with computer-based operations.

It is further noted, as disclosed herein, that the claims may be drafted to exclude any optional element. As such, this statement is intended to serve as antecedent basis for use of such exclusive terminology as “solely,” “only” and the like in connection with the recitation of claim elements, or use of a “negative” limitation. Unless defined otherwise herein, all technical and scientific terms used herein have the same meaning as commonly understood by one of ordinary skill in the art to which this invention belongs. The breadth of the present invention is not to be limited by the subject specification, but rather only by the plain meaning of the claim terms employed. The use of the terms “a” and “an” and “the” and similar referents in the context of describing the invention (especially in the context of the following claims) is to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

The use of any and all examples, or exemplary language (e.g., “such as”) provided herein, is intended merely to better illuminate the invention and does not pose a limitation on the scope of the invention unless otherwise claimed. It is understood that the preceding is merely a detailed description of some examples and embodiments of the present disclosure, and that numerous changes to the disclosed embodiments may be made in accordance with the disclosure made herein without departing from the spirit or scope of the disclosure. The preceding description, therefore, is not meant to limit the scope of the disclosure, but to provide sufficient disclosure to allow one of ordinary skill in the art to practice the disclosure without undue burden.

It is further understood that the scope of the present disclosure fully encompasses other embodiments that may become obvious to those skilled in the art. Features illustrated or described as part of one embodiment can be used in another embodiment to yield a still further embodiment. Thus, it is intended that the present disclosure cover such modifications and variations as come within the scope of the appended claims and their equivalents. It is to be understood by one of ordinary skill in the art that the present discussion is a description of exemplary embodiments only, and is not intended as limiting the broader aspects of the present disclosure, which broader aspects are embodied in the exemplary constructions.

1. A reinforced mat, comprising:
a plurality of boards arranged in a plurality layers;
wherein each of the plurality of layers are laminated to an adjacent one of the layers;
a plurality of dowels configured to be inserted to a bond line of each of the plurality of layers; and
wherein at least one of the plurality of dowels is configured to be aligned to and inserted into the bond line of each of the plurality of layers in order to provide structural integrity and enhance the service life of the mat.

2. The reinforced mat of claim 1, wherein the at least one dowel is a machined dowel sized to a certain pre-determined dimension having at least one scored thread pattern.

3. The reinforced mat of claim 1, wherein the at least one dowel is a soaked dowel treated with a certain treatment solution prior to insertion.

4. The reinforced mat of claim 1, wherein the at least one dowel is an adhesive coated dowel.

5. The reinforced mat of claim 1, wherein an aperture drilled inside each of the plurality of layers can be treated with a certain treatment solution prior to insertion of the at least one dowel either perpendicular or at an angle to the bond line of each of the plurality of layers.

6. The reinforced mat of claim 1, wherein the plurality of boards arranged in the plurality of layers comprises a cross-laminated timber panel.

7. The reinforced mat of claim 1, wherein the plurality of dowels inserted into the bond line prevent delamination of the board layer.

8. The reinforced mat of claim 1, wherein the plurality of dowels inserted into the bond line prevent any stress generated in the bond line caused by (a) bending and shear forces and/or (b) hygroscopic expansion and contraction during use of the panel.

9. The reinforced mat of claim 1, wherein the plurality of dowels inserted into the bond line of the plurality of boards prevent leading edge damage during use of the panel.

10. A panel comprising:
a plurality of dowels configured to be aligned along a bond line of a plurality of boards arranged in a plurality of layers, wherein each of the plurality of layers are laminated to an adjacent one of the layers;
wherein at least one of the plurality of dowels is configured to be aligned to and inserted into the bond line in order to provide structural integrity and enhance the service life the panel.

11. The panel of claim 10, wherein the at least one dowel is a machined dowel sized to a certain pre-determined dimension having at least one scored thread pattern.

12. The panel of claim 10, wherein the at least one dowel is a soaked dowel treated with a certain treatment solution prior to insertion.

13. The panel of claim 10, wherein the at least one dowel is an adhesive coated dowel.

14. The panel of claim 10, wherein an aperture drilled inside each of the plurality of layers can be treated with a certain treatment solution prior to insertion of the at least one dowel either perpendicular or at an angle to the bond line.

15. The panel of claim 10, wherein the plurality of boards arranged in the plurality of layers comprises a cross-laminated timber panel.

16. The panel of claim 10, wherein the plurality of dowels inserted into the bond line prevent delamination of the board layer.

17. The panel of claim 10, wherein the plurality of dowels inserted into the bond line prevent any stress generated in the bond line caused by (a) bending and shear forces and/or (b) hygroscopic expansion and contraction during use of the panel.

18. The panel of claim 10, wherein the plurality of dowels inserted into the bond line prevent leading edge damage during use of the panel.

19. A method of reinforcing a plurality of layers of boards, the method comprising the steps of:
providing a plurality of dowels;
dipping each of the plurality of dowels into an adhesive;
laminating each of a plurality of layers of boards to an adjacent one of the layers of boards;
aligning each of the plurality of dowels along a bond line of each of the plurality of layers of boards; and
drilling and inserting each of the plurality of dowels into the bond line in order to provide structural integrity and enhance the service life of each of the plurality of layers of boards.

20. The method of claim 19, wherein the at least one dowel is a machined dowel sized to a certain pre-determined dimension having at least one scored thread pattern.

21. The method of claim 19, wherein the at least one dowel is a soaked dowel treated with a certain treatment solution prior to insertion.

22. The method of claim 19, wherein the at least one dowel is an adhesive coated dowel.

23. The method of claim 19, wherein an aperture drilled inside each of the plurality of layers of boards can be treated with a certain treatment solution prior to insertion of the at least one dowel either perpendicular or at an angle to the bond line.

24. The method of claim 19, wherein the plurality of boards arranged in the plurality of layers of boards comprises a cross-laminated timber panel.

25. The method of claim 19, wherein the plurality of dowels inserted into the bond line prevent delamination of the board layer.

26. The method of claim 19, wherein the plurality of dowels inserted into the bond line prevent any stress generated in the bond line caused by (a) bending and shear forces and/or (b) hygroscopic expansion and contraction during use of the panel.

27. The method of claim 19, wherein the plurality of dowels inserted into the bond line prevent leading edge damage during use of the panel.

28. The method of claim 19, wherein the plurality of dowels inserted into the bond line prevent leading edge damage during use of the panels.

29. The method of claim 19, wherein the at least one dowel is red oak dowel.

30. The method of claim 19, further comprising the steps of:
using a scoring plate to create a pre-determined amount of compression during insertion of the at least one dowel; and
applying a high-tack glue during the patching process in order to provide a shock-proof temporary hold of the plurality of layers of boards.
